(19) United States
(12) Patent Application Publication
(10) Pub. No.: US 2022/0198452 A1
(43) Pub. Date: Jun. 23, 2022

(54) PAYMENT GATEWAY DISINTERMEDIATION

(71) Applicant: Shopify Inc., Ottawa (CA)

(72) Inventors: Nicholas CHEN, Toronto (CA); Zoe BRISCOE, Montreal (CA); Krystian CZESAK, Montreal (CA); Brice Lionel Frédéric ARGENSON, Montreal (CA)

(73) Assignee: Shopify Inc., Ottawa (CA)

(21) Appl. No.: 17/128,284

(22) Filed: Dec. 21, 2020

(51) Int. Cl. G06Q 20/40; G06Q 20/30

(52) U.S. Cl. CPC G06Q 20/401; G06Q 20/30

(57) ABSTRACT

A computer-implemented is disclosed. The method includes: receiving a first payment request for a merchant transaction from a first e-commerce platform; identifying a destination gateway associated with the merchant at a second e-commerce platform; and processing the first payment request for the merchant transaction from the first e-commerce platform using the destination gateway associated with the merchant at the second e-commerce platform, the processing including: obtaining one or more data modification parameters for the destination gateway, the one or more data modification parameters stored in association with the merchant by the second e-commerce platform, generating a second payment request based on a data payload associated with the first payment request and the one or more modification parameters for the destination gateway, and sending the second payment request to the destination gateway.

### FIELD

The present disclosure relates to computer-implemented e-commerce platforms and, in particular, to systems and methods for real-time payment request processing.

### BACKGROUND

E-commerce platforms provide merchants with various business support services, including payment processing services. The processing of online payments, whether by credit card, debit card, PayPal™, Amazon™ Pay, or the like, typically involves sending a payment request to a payment gateway. A payment gateway is a third-party operated gateway that receives payment requests from various sources and locations, extracts necessary data from each payment request, and formats it into a prescribed format for transmission to a payment server operated by a payment processor, such as a credit card company, bank, or the like. A payment gateway may also provide fraud prevention services and other ancillary services in connection with handling payment requests.

A merchant may use different payment gateways across different sales channels or e-commerce platforms. The activation of payment gateways for an e-commerce platform, or payment gateway “on-boarding”, can often be a complex process for merchants as it can require extensive configuration and provisioning.

### BRIEF DESCRIPTION OF THE DRAWINGS

Embodiments will be described, by way of example only, with reference to the accompanying figures wherein:

FIG. 1 is a block diagram of an e-commerce platform, according to an example embodiment;

FIG. 2 is an example of a home page of an administrator, according to an example embodiment;

FIG. 3 illustrates an example system for payments processing;

FIG. 4 shows, in flowchart form, an example method for processing, by an e-commerce platform, a payment request for a merchant transaction from a third-party e-commerce platform;

FIG. 5 shows, in flowchart form, an example method for processing, by an e-commerce platform, a payment authorization response for transmission to a third-party e-commerce platform; and

FIG. 6 shows, in flowchart form, another example method for processing, by an e-commerce platform, a payment request for a merchant transaction from a third-party e-commerce platform.

### DETAILED DESCRIPTION

In one aspect, the present application discloses a computer-implemented method. The method includes: receiving a first payment request for a merchant transaction from a first e-commerce platform; identifying a destination gateway associated with the merchant at a second e-commerce platform; and processing the first payment request for the merchant transaction from the first e-commerce platform using the destination gateway associated with the merchant at the second e-commerce platform, the processing including: obtaining one or more data modification parameters for the destination gateway, the one or more data modification parameters stored in association with the merchant by the second e-commerce platform; generating a second payment request based on a data payload associated with the first payment request and the one or more modification parameters for the destination gateway; and sending the second payment request to the destination gateway.

In some implementations, the method may further include: receiving, from the destination gateway, a payment authorization response; generating a modified payment authorization response for the first e-commerce platform; and forwarding the modified payment authorization response to a computing system associated with the first e-commerce platform.

In some implementations, the method may further include storing one or more payment request parameters associated with the first payment request, and the modified payment authorization response for the first e-commerce platform may be generated based on the payment authorization response and the payment request parameters.

In some implementations, the method may further include determining a product category associated with the merchant transaction, and the second payment request may be generated based on data requirements for a gateway that is configured to process payment data for the product category.

In some implementations, the method may further include determining a payment amount associated with the first payment request, and identifying the destination gateway may include selecting a payment gateway associated with the merchant based on the payment amount.

In some implementations, the method may further include retrieving, by the second e-commerce platform, merchant parameters associated with a merchant account from memory, and the second payment request may be generated based on the merchant parameters.

In some implementations, the first payment request may be received at a built-in gateway associated with the second e-commerce platform and the second payment request may be generated by the built-in gateway.

In some implementations, generating the second payment request may include modifying a data payload associated with the first payment request.

In some implementations, the method may further include determining gateway payload requirements associated with the destination gateway, and the data payload associated with the first payment request may be modified based on the gateway payload requirements.

In some implementations, the gateway payload requirements may specify a payload size limit and the data payload associated with the first payment request may be compressed in accordance with the payload size limit.

In another aspect, the present application discloses a computing system for processing payment requests associated with merchant transactions. The computing system includes a processor and a memory storing computer-executable instructions that, when executed, are to cause the processor to: receive a first payment request for a merchant transaction from a first e-commerce platform; identify a destination gateway associated with the merchant at a second e-commerce platform; and process the first payment request for the merchant transaction from the first e-commerce platform using the destination gateway associated with the merchant at the second e-commerce platform, the processing including: obtaining one or more data modification parameters for the destination gateway, the one or more data modification parameters stored in association with the merchant by the second e-commerce platform; generating a second payment request based on a data payload associated with the first payment request and the one or more modification parameters for the destination gateway; and sending the second payment request to the destination gateway.

In yet another aspect, the present application discloses a non-transitory, computer-readable medium storing computer-executable instructions that, when executed by a processor, are to cause the processor to carry out at least some of the operations of a method described herein.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

In the present application, the term “product data” refers generally to data associated with products that are offered for sale on an e-commerce platform. The product data for a product may include, without limitation, product specification, product category, manufacturer information, pricing details, stock availability, inventory location(s), expected delivery time, shipping rates, and tax and tariff information. While some product data may include static information (e.g., manufacturer name, product dimensions, etc.), other product data may be modified by a merchant on the e-commerce platform. For example, the offer price of a product may be varied by the merchant at any time. In particular, the merchant may set the product's offer price to a specific value and update said offer price as desired. Once an order is placed for the product at a certain price by a customer, the merchant commits to pricing; that is, the product price may not be changed for the placed order. Product data that a merchant may control (e.g., change, update, etc.) will be referred to as variable product data. More specifically, variable product data refers to product data that may be changed automatically or at the discretion of the merchant offering the product.

In the present application, the term “e-commerce platform” refers broadly to a computerized system (or service, platform, etc.) that facilitates commercial transactions, namely buying and selling activities over a computer network (e.g., Internet). An e-commerce platform may, for example, be a free-standing online store, a social network, a social media platform, and the like. Customers can initiate transactions, and any associated payment requests, via an e-commerce platform, and the e-commerce platform may be equipped with transaction/payment processing components or delegate such processing activities to one or more third-party services. An e-commerce platform may be extendible by connecting one or more additional sales channels representing platforms where products can be sold. In particular, the sales channels may themselves be e-commerce platforms, such as Facebook Shops™, Amazon™, etc.

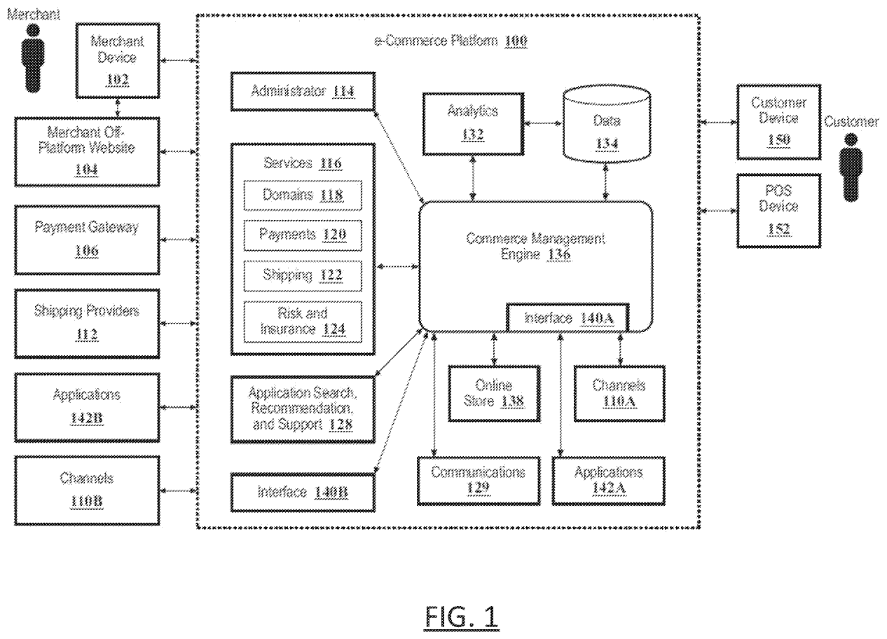

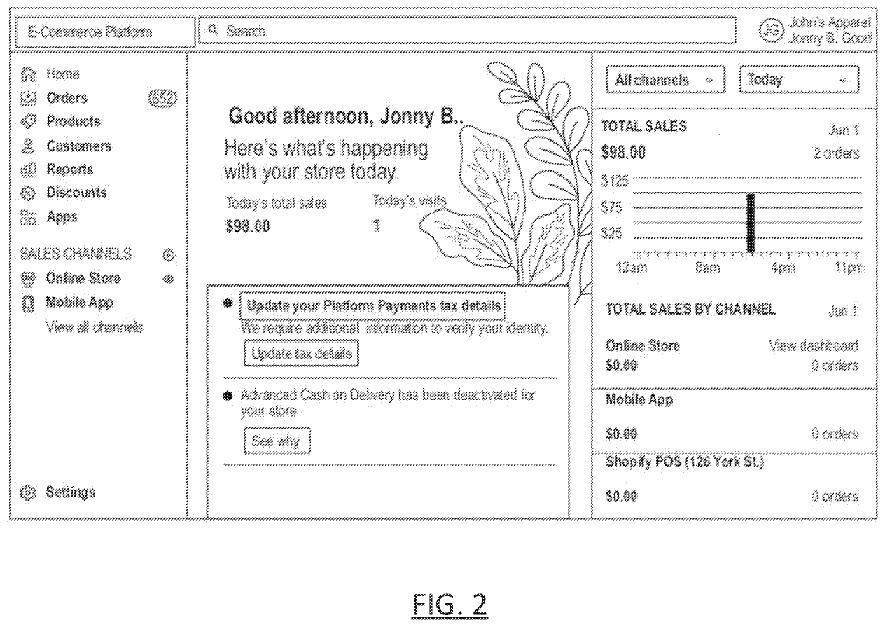

An example e-commerce platform 100 is described in detail below, with reference to FIGS. 1 and 2. For clarity, the e-commerce platform 100 will be distinguished from services/channels/platforms/etc. that are configured to connect to the e-commerce platform 100 for expanding the market for merchants' products. Such services/channels/platforms will be referred to as “third-party e-commerce platforms” throughout the following description.

### Example E-Commerce Platform

In some embodiments, the methods disclosed herein may be performed on or in association with an e-commerce platform. An example of an e-commerce platform will now be described.

FIG. 1 illustrates an e-commerce platform 100, according to one embodiment. The e-commerce platform 100 may be used to provide merchant products and services to customers. While the present disclosure contemplates using the apparatus, system, and process to purchase products and services, for simplicity the description herein will refer to products. All references to products throughout this disclosure should be understood to be references to products and/or services, including physical products, digital content, tickets, subscriptions, services to be provided, and the like.

While the disclosure throughout contemplates that a “merchant” and a “customer” may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to “merchants” and “customers”, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products, an enterprise user, a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed, in part or in whole, through a machine that executes computer software, modules, program codes, and/or instructions on one or more processors which may be part of or external to the e-commerce platform 100. Merchants may utilize the e-commerce platform 100 for managing commerce with customers, such as by implementing an e-commerce experience with customers through an online store 138, through channels 110A-B, through point-of-sale (POS) devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., “brick-and-mortar” retail stores), a merchant off-platform website 104 (e.g., a commerce Internet website or other internet or web property or asset supported by or on behalf of the merchant separately from the e-commerce platform), and the like. However, even such other merchant commerce facilities may be incorporated into the e-commerce platform, such as where POS devices 152 in a physical store of a merchant are linked to the e-commerce platform 100, where a merchant off-platform website 104 is tied to the e-commerce platform 100, such as through “buy buttons” that link content from the merchant off platform website 104 to the online store 138, and the like.

The online store 138 may represent a multitenant facility comprising a plurality of virtual storefronts. In some embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138 a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A-B may be provided internal to the e-commerce platform 100 or from outside the e-commerce platform 100. A merchant may sell in their physical retail store, at pop-ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communications facility 129 to leverage customer interactions and analytics 132 to improve the probability of sales. Throughout this disclosure, the terms “online store” and “storefront” may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In some embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via communications facility 129, and the like, providing a system for reaching customers and facilitating merchant services for the real or virtual pathways available for reaching and interacting with customers.

In some embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, POS devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client, such as a thin client, via a web browser or other application, accessed through by POS devices, and the like). In some embodiments, elements of the e-commerce platform 100 may be implemented to operate on various platforms and operating systems, such as iOS™, Android™, on the web, and the like (e.g., the administrator 114 being implemented in multiple instances for a given online store for iOS™, Android™, and for the web, each with similar functionality).

In some embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150, and then the template language is replaced by data from the online store 138, such as when a theme is installed. The template and themes may consider tags, objects, and filters. The client device web browser (or other application) then renders the page accordingly.

In some embodiments, online stores 138 may be served by the e-commerce platform 100 to customers, where customers can browse and purchase the various products available (e.g., add products to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their website through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store 138 may implement a content management system for website content. Merchants may author blog posts or static pages and publish them to their online store 138, such as through blogs, articles, and the like, as well as configure navigation menus. Merchants may upload images (e.g., for products), videos, content, data, and the like to the e-commerce platform 100, such as for storage by the system (e.g., as data 134). In some embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services (identified as services 116 in FIG. 1), an administrator 114, and the like associated with running an on-line business, such as providing a domain service 118 associated with their online store, payments facility 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

FIG. 2 depicts a non-limiting embodiment for a home page of an administrator 114, which may show information about daily tasks, a store's recent activity, and the next steps a merchant can take to build their business. In some embodiments, a merchant may log in to administrator 114 via a merchant device 102 such as from a desktop computer or mobile device, and manage aspects of their online store 138, such as viewing the online store's recent activity, updating the online store's catalog, managing orders, recent visits activity, total orders activity, and the like. In some embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store, POS devices, and/or a buy button. The administrator 114 may also include interfaces for managing applications installed on the merchant's account, and settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g., via a mobile application), they may be able to view all or a subset of the aspects of their online store 138, such as viewing the online store's recent activity, updating the online store's catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a “view all recent activity” dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide payments facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's bank account (e.g., when using capital), and the like. These systems may have Sarbanes-Oxley Act (SOX) compliance and a high level of diligence required in their development and operation. The payments facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They may also connect and onboard new merchants with the e-commerce platform 100. These services may enable merchant growth by making it easier for merchants to work across the e-commerce platform 100. Through these services, merchants may be provided help facilities via the e-commerce platform 100.

In some embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In some embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in some embodiments the e-commerce platform 100 may be configured with a commerce management engine 136 for content management, task automation, and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services. The applications 142A may be provided internal to the e-commerce platform 100 or applications 142B may be provided from outside the e-commerce platform 100. In some embodiments, an application 142A may be provided by the same party providing the e-commerce platform 100 or by a different party. In some embodiments, an application 142B may be provided by the same party providing the e-commerce platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion in the commerce management engine 136 may need to exceed a core functionality threshold through which it may be determined that the function is core to a commerce experience (e.g., common to a majority of online store activities, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the e-commerce platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the e-commerce platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, rather than violating the isolation principle, it may be preferred to move these components out of the commerce management engine 136 and into their own infrastructure within the e-commerce platform 100.

In some embodiments, the e-commerce platform 100 may provide for a platform payments facility 120, which is another example of a component that utilizes data from the commerce management engine 136 but may be located outside so as to not violate the isolation principle. The platform payments facility 120 may allow customers interacting with online stores 138 to have their payment information stored safely by the commerce management engine 136 such that they only have to enter it once. When a customer visits a different online store 138, even if they have never been there before, the platform payments facility 120 may recall their information to enable a rapid and accurate checkout. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. Thus, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In some embodiments, core products, core extension points, applications, and the administrator 114 may be developed to work together. For instance, application extension points may be built inside the administrator 114 so that core features may be extended by way of applications, which may deliver functionality to a merchant through the extension.

In some embodiments, applications 142A-B may deliver functionality to a merchant through the interface 140A-B, such as where an application 142A-B is able to surface transaction data to a merchant (e.g., app: “engine, surface my app data in mobile and web admin using the embedded app SDK”), and/or where the commerce management engine 136 is able to ask the application to perform work on demand (e.g., engine: “app, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as by utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension/API 140A-B, help make products easy to view and purchase in a fast-growing marketplace. In some embodiments, partners, application developers, internal applications facilities, and the like, may be provided with a software development kit (SDK), such as through creating a frame within the administrator 114 that sandboxes an application interface. In some embodiments, the administrator 114 may not have control over or be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, for synchronizing a local database, notifying an external integration partner, and the like. Update events may enable this functionality without having to constantly poll the commerce management engine 136 to check for updates, such as through an update event subscription. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator 114, or automatically (e.g., via the API 140A-B). In some embodiments, update events may be queued and processed asynchronously from a state change that triggered them, which may produce an update event notification that is not distributed in real-time.

In some embodiments, the e-commerce platform 100 may provide application search, recommendation and support 128 functionalities. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized for application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In some embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, and integration applications. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In some embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In some embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)), and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In some embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping rates based on the customer's shipping address. Checkout may delegate the calculation of taxes to a tax component and the calculation of shipping rates to a delivery component. A pricing component may enable merchants to create discount codes (e.g., “secret” strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping rate is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency, or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In some embodiments, the payment gateway 106 may accept international payment, such as integrating with leading international credit card processors. The card server environment may include a card server application, card sink, hosted fields, and the like. This environment may act as the secure gatekeeper of the sensitive credit card information. In some embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like.

At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts, to avoid over-selling (e.g., merchants may control this behavior from the inventory policy of each variant). Inventory reservation may have a short time span (e.g., minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order, or incoming from an inventory transfer component (e.g., from a vendor).

The merchant may then review and fulfill (or cancel) the order. A review component may implement a business process merchants use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In some embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. Conditions may be imposed on returns, such as requiring that they be initiated within a set period (e.g., 30 days) of the original order date. The business process merchants may go through to “un-sell” an item may be implemented by a return component. Returns may consist of a variety of different actions, such as: a re-stock, where the product that was sold actually comes back into the business and is sellable again; a refund, where the money that was collected from the customer is partially or fully returned; an accounting adjustment noting how much money was refunded (e.g., including if there were any re-stocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Payment Gateways

As noted above, the checkout process often involves a payment processing job carried out, in part, by one of the payment gateways 106. Payment gateways 106 may be third-party servers that are used to receive payment requests, initiate payment processing with a payment processor and, in some cases, provide fraud checking on behalf of the merchant. In the description herein, the payment gateways 106 may be described as “processing payments”; however, it will be appreciated that the payment gateways 106 may not complete payment processing on their own. The payment gateway 106 is typically a first step in payment processing, and it may pass along payment information in a determined format to a specific payment processor to complete the payment processing. The payment gateway 106 then receives a success or failure message from the payment processor and prepares and sends a response message to the sender of the payment request.

The payment gateways 106 typically process the payments for a fee and/or a percentage cut of the transaction. In some instances, one or more of the payment gateways 106 may be provided by the e-commerce platform itself; however, in many cases, the payment gateway 106 is implemented by an external payment gateway provider and each payment gateway 106 may serve a large number of e-commerce platforms, individual merchants, and others.

Each payment gateway 106 may have its own characteristics in terms of the types of payments it processes, for example Mastercard™ credit card payments, Visa™ credit card payments, PayPal™ transactions, Apple Pay™ transactions, STAR™ debit transactions, Interac™ debit transactions, etc. Some payment gateways 106 may handle multiple types of payments, while some may specialize in one type of payment. Some payment gateways 106 may have restrictions on certain types of transactions that it will not handle, e.g., product restrictions, transaction value limits, or other such restrictions. Some payment gateways 106 may be configured for higher throughput than other payment gateways 106. Each payment gateway 106 typically charges a fee, which may include a percentage of the total transaction value, for processing a payment and performing any fraud prevention/checking involved.

The e-commerce platform 100 may have a list of payment gateways 106 available for processing payments. In some cases, a merchant may designate a particular payment gateway 106 as their preferred gateway for processing transactions, or transactions of a particular type. The selection may often be based on the merchant's assessment of the payment gateway's reliability, speed, and cost. The e-commerce platform 100 and/or the merchant may have an ordered list of payment gateways 106 in order of preference. The order of preference may be based on cost or other factors.

The activation of a new payment gateway on an e-commerce platform, or sales channel, can be a complex process for merchants, as it often requires a significant amount of configuration. As they expand their product offerings and enter new marketplaces, merchants face additional challenges in gateway on-boarding—the risk profiles of certain product categories and use of cross-border commerce can lead to a high level of complexity which may prevent some merchants from using their preferred payment gateways. For example, when a merchant attempts to expand into a new sales channel, the marketplace may not accept the merchant's preferred payment gateway (e.g., if the gateway is enabled to transact in high-risk or non-approved product categories), and may require a new gateway relationship to be established.

In order to accommodate merchants with varying risk profiles, it is desired to provide a payment processing solution for e-commerce platforms that provides customized payment gateway support across multiple platforms/channels and that allows merchants to designate their own gateways for processing transactions without the need for independent re-provisioning on the platforms/channels.

In one aspect, the present application proposes systems and methods for real-time payment request processing. More specifically, a payment gateway relay for facilitating routing of payment request data to third-party gateways is described. The payment gateway relay passes data associated with payment requests to third-party gateway servers that are associated with payment service providers (PSPs). The payment gateway relay configures the payment requests based on existing product and/or merchant configuration data and routes the formatted payment requests to their respective destination gateways.

The disclosed payment gateway relay exposes its APIs to third-party commerce channels (e.g., Facebook, Amazon, etc.). The third-party commerce channels can rely on the payment gateway relay for payment formatting/translation rather than having to make direct arrangements with each destination gateway and customize payment requests for those destination gateways' protocols. The payment gateway relay receives a payment request associated with a merchant and inspects the payload body of the request. The request parameters associated with the payment request are stored. Based on the known identity of the merchant and their current payment configurations, the payment gateway relay configures the payment data request to a format that is acceptable for the destination gateway. When a response is received from the destination gateway, it can translate the response to match the original payment request.

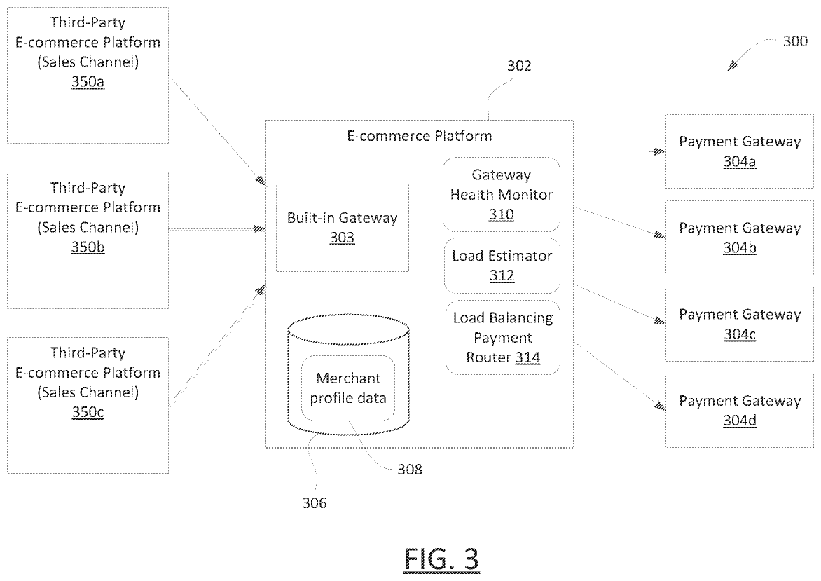

FIG. 3 illustrates an example system 300 in block diagram form. The system 300 includes an e-commerce platform 302, a plurality of payment gateways (shown individually as 304a, 304b, 304c and 304d), and a plurality of third-party e-commerce platforms (shown individually as 350a, 350b and 350c). The payment gateways 304a-d are third-party operated independent payment processing systems. The e-commerce platform 302 includes, among other things, data storage 306, which may contain various types of data including merchant data 308. The merchant data 308 may include data associated with the merchant(s) including preferred gateways for payment processing, etc.

The e-commerce platform 302 may include a gateway health monitor 310 that monitors the status of the payment gateways 304a-d. As an example, the gateway health monitor 310 may obtain data regarding the current loads and response times of each of the payment gateways 304a-d. In some cases, a payment gateway may be configured to provide metrics in response to a health request message from the e-commerce platform 302. For example, using a publish-subscribe type of service, the e-commerce platform 302 may register with a payment gateway to receive periodic messages from the payment gateways providing current status information regarding the gateway. In some cases, the messages may be provided by a payment gateway in reply to a request from the e-commerce platform 302.

The current health status information provided by the payment gateways 304a-d may vary from gateway to gateway depending on data it is configured to provide. In some cases, a payment gateway may provide one or more of “current load”, “current cap”, average payment request handling time, scalability options, or other configuration data regarding the payment gateway. The current load may be a count of total current payment requests being processed by the payment gateway. The current load may be a count of received requests over a short recent time period, such as the past 10 seconds, 30 seconds, minute, or another window.

The current cap may be a pre-selected maximum number of payment requests that the payment gateway is configured to accept. For example, the payment gateway may be configured to have a set maximum number of active payment requests. If the maximum is reached, then new payment requests may be automatically refused until processing of payments brings the count of active requests down below the maximum.

In some cases, the e-commerce platform 302 may measure response time of one of the payment gateways 304a-d. As an example, the e-commerce platform 302 may use a common ping message to determine the round-trip response time of a payment gateway. In some cases, the e-commerce platform 302 may track the payment processing time for payment requests sent to each of the gateways (such as determining a payment processing time of one or multiple requests over a predetermined time period) to track the overall response times of each of the payment gateways 304a-d. In cases where a payment gateway does not provide current load information, the e-commerce platform 302 may attempt to infer health status from measured response times.

Based on information obtained from the payment gateways 304a-d and/or inferred from measured response times from the payment gateways 304a-d, the e-commerce platform 302 may maintain a current status record for each of the payment gateways 304a-d. The current status of a gateway may include a measurement or estimation of the available capacity of the payment gateway.

The e-commerce platform 302 may further include a load estimator 312. The load estimator 312 is configured to anticipate potential or likely load events based on data available to the e-commerce platform 302. The data may include data regarding a specific merchant store and/or activity on the e-commerce platform 302 with regard to that merchant store and customers of that merchant. The data may also or alternatively include data regarding a plurality of merchant stores, e.g., overall merchant or customer activity on the e-commerce platform 302.

The load estimator 312 may be configured to identify potential load events, e.g., an anticipated spike or surge in payment requests. The load estimator 312 may identify these events using data regarding activity on the e-commerce platform 302, such as number of site visits, active shopping carts, count of selected product items, etc. In some cases, the load estimator 312 may use data from outside the e-commerce platform 302, such as information regarding significant calendar dates for purchasing (e.g., Black Friday), or information regarding merchant-specific events, such as a planned flash sale, marketing campaign launch, or other such event.

The e-commerce platform 302 may further include a load balancing payment router 314. The load balancing payment router 314 may direct payment requests to one of the payment gateways 304a-d. The selection of one of the payment gateways 304a-d may be based on the configured preferences of a merchant associated with the payment request and may, in some cases, depend on the type of payment or type of product.

The load balancing payment router 314 may receive information regarding payment gateway health from the gateway health monitor 310 and may receive anticipated load information from the load estimator 312. From this data, the load balancing payment router 314 may identify when an anticipated load event is likely to overwhelm a particular payment gateway, e.g., payment gateway 304a. As an example, the anticipated load event may project a certain number of payment requests in a certain time period in connection with a specific merchant. The available capacity at a preferred payment gateway for that merchant may be insufficient to handle the projected number of payment requests. Accordingly, the load balancing payment router 314 may identify an alternative payment gateway (e.g., payment gateway 304b) and may proactively route at least some of the payment requests to the alternative payment gateway 304b to reduce the likelihood of the primary payment gateway 304a becoming overloaded. It will be appreciated that after identifying an anticipated load event for a specific merchant store on a primary payment gateway 304a, the load balancing payment router 314 may also proactively route payment requests from other merchant stores away from the primary payment gateway 304a and to an alternative payment gateway 304b.

It will be appreciated that although the gateway health monitor 310, the load estimator 312, and the load balancing payment router 314 are illustrated as separate elements for ease of explanation, they may be implemented as separate software applications or modules, or partially or completely together as one software application or module, or as part of a larger software application or module, within or outside the platform 302.

The third-party e-commerce platforms 350a-c represent additional sales channels which may be connected to the e-commerce platform 302. In particular, the e-commerce platform 302 may be extended by connecting one or more third-party e-commerce platforms (e.g., Facebook Shop™, Amazon™, etc.), allowing merchants to offer their products for sale on these third-party e-commerce platforms. By connecting the third-party e-commerce platforms 350a-c, merchants can track their products, orders and customers for those sales channels on the e-commerce platform 302.

Once a third-party e-commerce platform is connected to the e-commerce platform 302, customers may be able to check out either at a merchant's online store on the e-commerce platform 302 or directly on the third-party e-commerce platform using an existing checkout service for the third-party e-commerce platform. Each checkout method has unique features (e.g., allowing discounts, custom branding, pre-order options, ad targeting, etc.), fees and eligibility requirements for merchants. Payments for merchant transactions on the third-party e-commerce platforms 350a-c may be processed by the e-commerce platform 302. In particular, payment requests associated with a merchant's transactions may be sent to the e-commerce platform 302 to be relayed to a suitable payment gateway that is designated by the merchant. For example, the payment requests may be routed to a built-in gateway 303 associated with the e-commerce platform 302, which may itself process the payment requests or relay the payments requests to suitable destination gateways for processing.

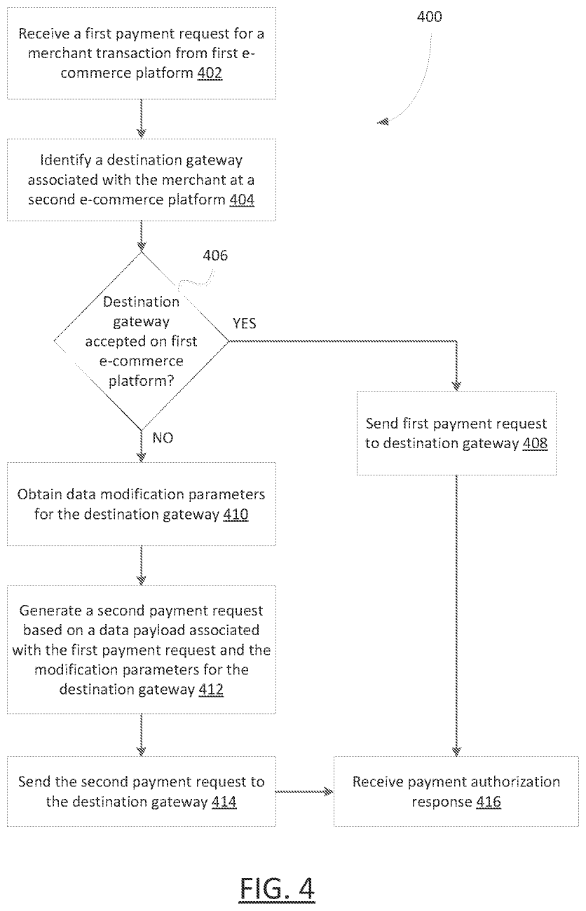

Reference is made to FIG. 4, which shows, in flowchart form, an example method 400 for processing a payment request for a merchant transaction from a third-party e-commerce platform. The method 400 may be implemented by an e-commerce platform, which may include one or more computing devices with memory and processors executing computer-readable instructions to carry out the operations described. In particular, a payment gateway associated with the e-commerce platform may perform the operations of method 400. For example, a built-in payment gateway that is configured to receive payment requests in connection with customer purchases may perform the operations of method 400. The e-commerce platform may serve a plurality of merchant accounts, including merchant storefronts or websites for retailing of product items, and providing payment services to the merchant accounts in connection with customer purchases of product items.

In operation 402, the e-commerce platform receives a first payment request for a merchant transaction from a third-party e-commerce platform. The first payment request may be forwarded by the third-party e-commerce platform following a customer purchase activity. When a customer initiates a transaction on the third-party e-commerce platform for a product that is offered by a merchant associated with the e-commerce platform, the payment request associated with that transaction is sent to a payment processing component of the e-commerce platform. For example, if a customer is purchasing a product from a storefront for the merchant on the third-party e-commerce platform, a payment request associated with the purchase may be sent to the e-commerce platform for processing.

The first payment request may be a request message that includes details about the merchant transaction. More particularly, the payload (or message) of the first payment request may include transaction data associated with the merchant transaction. The payload may include, for example, a transaction identifier, merchant name and identifier, customer information, transaction amount, purchased product (i.e., good or service), transaction date/time, payment type (e.g., credit card payment, etc.), and transaction location (e.g., point-of-sale, online storefront, etc.).

In operation 404, the e-commerce platform identifies a destination gateway associated with the merchant at the e-commerce platform. In some embodiments, the destination gateway may be specified in the data payload associated with the first payment request. For example, the destination gateway may be a gateway that is designated by the merchant as a preferred gateway for processing transactions for that merchant. The payload may indicate, at least, a gateway identifier and an address for the gateway.

Additionally, or alternatively, the destination gateway associated with the merchant may be determined based on merchant account data stored by the e-commerce platform. That is, the merchant account data may indicate a destination gateway, or preferred gateway, for the merchant and the e-commerce platform may be configured to retrieve the stored merchant account data to determine the destination gateway.

The first payment request for the merchant transaction is processed using the destination gateway associated with the merchant. More specifically, the requested payment for the merchant transaction is processed, by forwarding payment data associated with the requested payment to the destination gateway. In operation 406, the e-commerce platform determines whether the destination gateway is accepted on the third-party e-commerce platform. The destination gateway may, for example, be a gateway that has not been enabled, or on-boarded, on the third-party e-commerce platform, i.e., a gateway relationship has not yet been established for the destination gateway on the third-party e-commerce platform. In at least some embodiments, the e-commerce platform may query the third-party e-commerce platform (e.g., via an API call) to check whether the destination gateway has been on-boarded. For example, the query may include gateway information for the destination gateway (e.g., gateway identifier, address, etc.), and the query response may indicate whether the destination gateway is enabled for the third-party e-commerce platform. In some embodiments, the e-commerce platform may itself check to determine whether the destination gateway is accepted on the third-party e-commerce platform. For example, the e-commerce platform may store payment gateway data in connection with one or more third-party e-commerce platforms. The payment gateway data may specify, for example, properties of gateways which are, or are not, accepted by the third-party e-commerce platforms. The e-commerce platform may determine properties of the destination gateway (e.g., product categories, transaction amount limits, etc.), and upon comparing with the payment gateway data for the third-party e-commerce platform, determine whether the destination gateway would be accepted.

If the destination gateway is determined to be accepted on the third-party e-commerce platform, the e-commerce platform sends the first payment request to the destination gateway, in operation 408. The destination gateway is enabled on the third-party e-commerce platform, and so the first payment request can be processed by the destination gateway. If, on the other hand, the destination gateway is determined to be not accepted on the third-party e-commerce platform, the e-commerce platform is configured to translate the payment data associated with the first payment request to a request format that is suitable for the destination gateway. For example, if the destination gateway is enabled for transacting in high-risk product categories and therefore not accepted on the third-party e-commerce platform, the e-commerce platform may provide a payment translation layer for relaying the payment data associated with the first payment request to the destination gateway. In this way, the proposed system for payment processing allows the merchant to avoid having to establish a new gateway relationship agreement (which may be a tedious and error-prone process) with the third-party e-commerce platform, while routing payment information to the merchant's preferred gateway using existing configurations already in place for the e-commerce platform to complete the transaction in the third-party e-commerce platform.

In operation 410, the e-commerce platform obtains data modification parameters for the destination gateway. For merchant preferred gateways, the data modification parameters are stored in association with the merchant by the e-commerce platform, and are used by the e-commerce platform to translate the first payment request into a data format that is suitable for the destination gateway. The data modification parameters may indicate, for example, a message format and data fields (e.g., required and optional fields) for payment requests that are readable by the destination gateway.

In operation 412, the e-commerce platform generates a second payment request, based on the data payload associated with the first payment request and the one or more modification parameters for the destination gateway. The second payment request represents a translation of the first payment request to a data format that is accepted by the destination gateway. More specifically, the data payload associated with the second payment request includes some or all of the payment data for the same requested payment for the merchant transaction from the third-party e-commerce platform. The data payload for the second payment request may be obtained based on modifying the data payload for the first payment request. For example, the data payload for the first payment request may be modified in accordance with the one or more data modification parameters associated with the destination gateway.

In at least some embodiments, the e-commerce platform may retrieve, from one or more databases, supplementary data which may be used for generating the second payment request. That is, the second payment request may be generated based on the data payload associated with the first payment request, the one or more modification parameters for the destination gateway, and supplementary data stored in memory that is accessible to the e-commerce platform. For example, the e-commerce platform may generate queries based on data items included in the data payload associated with the first payment request and retrieve supplementary data from one or more database based on the generated queries. The queries may, for example, be used for retrieving merchant-specific data (e.g., historical payments processing data, gateway preference data, etc.) that is stored in association with one or more merchants on the e-commerce platform. The retrieved data items may then be included in data payload for the second payment request. For example, one or more of the retrieved data items may be required to be included in the second payment request, while other ones of the data items may be optionally included. Additionally, or alternatively, the retrieved data items may inform the translation of the first payment request to the second payment request. In particular, the e-commerce platform may generate the second payment request based on settings (e.g., request parameters, format requirements, etc.) that are determined from the retrieved supplementary data.

In some embodiments, the e-commerce platform may determine gateway payload requirements associated with the destination gateway. For example, the e-commerce platform may obtain, from the destination gateway, data requirements for payment requests that are accepted by the destination gateway. Additionally, or alternatively, the e-commerce platform may store gateway requirements data for one or more payment gateways. The requirements data may specify, for example, a payload size limit for payment requests. The e-commerce platform may generate the second payment request such that it complies with the gateway requirements data for the destination gateway. For example, the data payload for the first payment request may be compressed in accordance with the payload size limit for the destination gateway when generating the data payload for the second payment request.

In operation 414, the e-commerce platform sends the second payment request to the destination gateway. In particular, the e-commerce platform routes the second payment request based on address information associated with the destination gateway. In operation 416, the e-commerce platform receives a payment authorization response from the destination gateway.

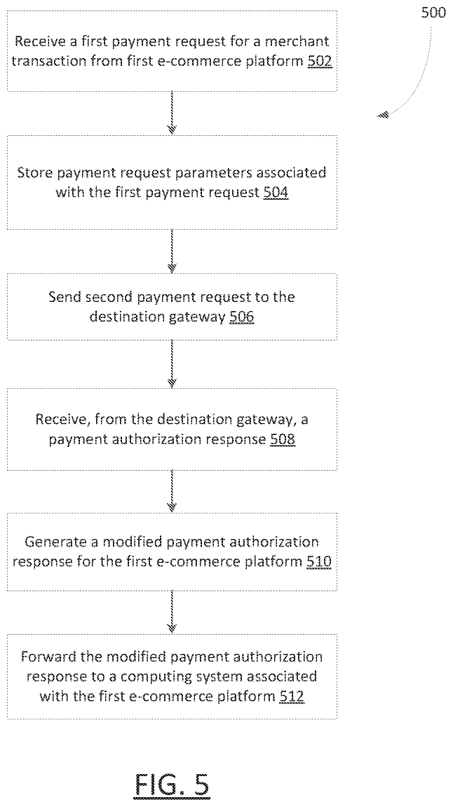

Reference is now made to FIG. 5, which shows, in flowchart form, an example method 500 for processing, by an e-commerce platform, a payment authorization response for transmission to a third-party e-commerce platform. It will be understood that the e-commerce platform may be configured to perform the operations of method 500 in addition to and/or in combination with one or more of the operations of method 400 of FIG. 4 when processing merchant transactions that are initiated on third-party e-commerce platforms.

In operation 502, the e-commerce platform receives a first payment request for a merchant transaction from a third-party e-commerce platform. The first payment request may be forwarded to the e-commerce platform following a purchase transaction on the third-party e-commerce platform. Additionally, or alternatively, the e-commerce platform may receive a request to process a merchant transaction on the third-party e-commerce platform, and the transaction request may identify a corresponding payment request (e.g., a request to process a payment for the transaction amount associated with the merchant transaction).

In operation 504, the e-commerce platform stores one or more payment request parameters associated with the first payment request. That is, the e-commerce platform inspects the payment request and stores data (i.e., parameters) in connection with the payment request. The payment request parameters may include, for example, identification information for the third-party e-commerce platform, transaction identifier, merchant identifier, customer information, date and time of request, message format of the payment request, and the like.

In operation 506, the e-commerce platform sends a second payment request to the destination gateway. The second payment request represents a translation of the payment data associated with the first payment request for the merchant transaction. The second payment request may be generated by the e-commerce platform in accordance with the techniques described with reference to method 400. In particular, the e-commerce platform may generate the second payment request by modifying the data payload associated with the first payment request and one or more data modification parameters associated with the destination gateway.

In operation 508, the e-commerce platform receives, from the destination gateway, a payment authorization response. The payment authorization response is a message provided by a payment processor indicating whether the requested payment is authorized or whether it is rejected. The payment authorization response may, for example, be issued by a card issuing bank for a credit or debit card that was used for the requested payment, and forwarded to the destination gateway by a payment processor for the merchant's acquiring bank.

The payment authorization response may not be suitably formatted for the third-party e-commerce platform. In particular, the payment authorization response may need to be formatted by the translation layer of the e-commerce platform, just as the first payment request for the merchant transaction was translated (to the second payment request). In operation 510, the e-commerce platform generates a modified payment authorization response for the third-party e-commerce platform. The modified payment authorization response is generated based on the payment authorization response (i.e., the original response message provided to the destination gateway) and the one or more payment request parameters associated with the first payment request. Thus, the translation function of the e-commerce platform operates to convert the first payment request to a second payment request that is readable by the destination gateway and to convert the payment authorization response to match the original payment request from the third-party e-commerce platform.

In operation 512, the e-commerce platform forwards the modified payment authorization response to a computing system associated with the third-party e-commerce platform. In some embodiments, the modified payment authorization response may be routed to an order fulfilment module associated with the third-party e-commerce platform.

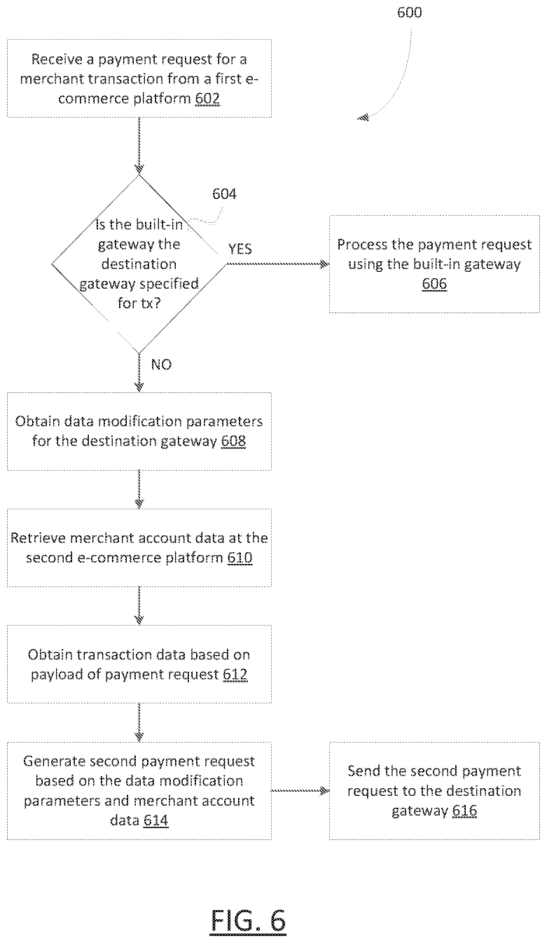

Reference is now made to FIG. 6, which shows, in flowchart form, another example method 600 for processing, by an e-commerce platform, a payment request for a merchant transaction from a third-party e-commerce platform. It will be understood that the e-commerce platform may be configured to perform the operations of method 600 in addition to and/or in combination with one or more of the operations of method 400 of FIG. 4 and method 500 of FIG. 5 when processing merchant transactions that are initiated on third-party e-commerce platforms.

In operation 602, the e-commerce platform receives a payment request for a merchant transaction from a third-party e-commerce platform. In operation 604, the e-commerce platform determines whether a built-in gateway associated with the e-commerce platform is the destination gateway specified for the merchant transaction. A “built-in” gateway may be a gateway that is designated as a default payment gateway for the e-commerce platform. Payment requests associated with transactions for a merchant that has a merchant account on the e-commerce platform may first be directed to the built-in gateway, and possibly rerouted by the built-in gateway to a different payment gateway connected to the e-commerce platform. The e-commerce platform may check the transaction data for the first payment request or retrieve merchant account data for the merchant to determine the destination (or preferred) gateway for the merchant.

If the built-in gateway is designated as the destination gateway, the payment request is processed using the built-in gateway, in operation 606. That is, the transaction data for the payment request is provided to the built-in gateway for further processing, i.e., requesting authorization for the payment, etc.

On the other hand, if a different payment gateway is designated by the merchant transaction as the destination gateway, the e-commerce platform obtains data modification parameters for the destination gateway, in operation 608. The data modification parameters indicate requirements for payment requests that are readable by the destination gateway and may specify, for example, a message format and data fields (e.g., required and optional fields) for payment requests.

In operation 610, the e-commerce platform retrieves merchant account data, which is stored at the e-commerce platform. The merchant account data may include, for example, designated preferences of the merchant for transactions on the e-commerce platform as well as third-party e-commerce platforms. In some embodiments, the merchant account data may include a list (e.g., an ordered list) of payment gateways that are preferred by the merchant for processing specific types of transactions. The choice of destination gateway (and, accordingly, the data modification parameters) may be based on the retrieved merchant account data.

In operation 612, the e-commerce platform obtains transaction data associated with the merchant transaction based on the payload of the first payment request. For example, the e-commerce platform may inspect the data payload associated with the first payment request and extract transaction parameters associated with the requested merchant transaction. The transaction data for the first payment request may indicate, among others, a payment amount, payor and payee identifiers, requested payment date/time, and product information for the purchased product such as product category, quantity, etc.

In operation 614, the e-commerce platform generates a second payment request based on the data modification parameters, the merchant account data, and the transaction data. In particular, the second payment request is generated such that it contains the transaction data associated with the first payment request and is also in accordance with the merchant parameters associated with the merchant account and the transaction data for the merchant transaction. In operation 616, the e-commerce platform sends the second payment request to the destination gateway.

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method for processing payment requests, the method comprising:
receiving a first payment request for a merchant transaction from a first e-commerce platform;
identifying a destination gateway associated with the merchant at a second e-commerce platform; and
processing the first payment request for the merchant transaction from the first e-commerce platform using the destination gateway associated with the merchant at the second e-commerce platform, the processing including:
obtaining one or more previously stored data modification parameters for the destination gateway and transaction data indicating a product category associated with the merchant transaction, the one or more data modification parameters stored in association with the merchant by the second e-commerce platform and;
translating payment data associated with the first payment request to a request data format accepted by the destination gateway by generating a second payment request based on modifying the data payload associated with the first payment request using the one or more modification parameters for the destination gateway and data requirements for a gateway that is configured to process payment data for the product category; and
sending the second payment request to the destination gateway;
receiving, from the destination gateway, a payment authorization response indicating whether a payment associated with the second payment request is authorized;
converting the payment authorization response to a response data format that matches the first payment request by generating a modified payment authorization response for the first e-commerce platform; and
forwarding the modified payment authorization response to a computing system associated with the first e-commerce platform.

2. (canceled)

3. The method of claim 1, further comprising storing one or more payment request parameters associated with the first payment request, wherein the modified payment authorization response for the first e-commerce platform is generated based on the payment authorization response and the payment request parameters.

4. (canceled)

5. The method of claim 1, further comprising determining a payment amount associated with the first payment request, wherein identifying the destination gateway comprises selecting a payment gateway associated with the merchant based on the payment amount.

6. The method of claim 1, further comprising retrieving, by the second e-commerce platform, merchant parameters associated with a merchant account from memory, wherein the second payment request is generated based on the merchant parameters.

7. The method of claim 1, wherein the first payment request is received at a built-in gateway associated with the second e-commerce platform and wherein the second payment request is generated by the built-in gateway.

8. (canceled)

9. The method of claim 1, further comprising determining gateway payload requirements associated with the destination gateway, wherein the data payload associated with the first payment request is modified based on the gateway payload requirements.

10. The method of claim 9, wherein the gateway payload requirements specify a payload size limit and wherein the data payload associated with the first payment request is compressed in accordance with the payload size limit.

11. A computing system, comprising:
a processor;
a memory storing computer-executable instructions that, when executed by the processor, are to cause the processor to:
receive a first payment request for a merchant transaction from a first e-commerce platform;
identify a destination gateway associated with the merchant at a second e-commerce platform; and
process the first payment request for the merchant transaction from the first e-commerce platform using the destination gateway associated with the merchant at the second e-commerce platform, the processing including:
obtaining one or more previously stored data modification parameters for the destination gateway and transaction data indicating a product category associated with the merchant transaction, the one or more data modification parameters stored in association with the merchant by the second e-commerce platform;
translating payment data associated with the first payment request to a request data format accepted by the destination gateway by generating a second payment request based on modifying the data payload associated with the first payment request using the one or more modification parameters for the destination gateway and data requirements for a gateway that is configured to process payment data for the product category; and
sending the second payment request to the destination gateway;
receive, from the destination gateway, a payment authorization response indicating whether a payment associated with the second payment request is authorized;
convert the payment authorization response to a response data format that matches the first payment request by generating a modified payment authorization response for the first e-commerce platform; and
forward the modified payment authorization response to a computing system associated with the first e-commerce platform.

12. (canceled)

13. The computing system claimed in claim 11, wherein the instructions, when executed, are to cause the processor to store one or more payment request parameters associated with the first payment request, wherein the modified payment authorization response for the first e-commerce platform is generated based on the payment authorization response and the payment request parameters.

14. (canceled)

15. The computing system claimed in claim 11, wherein the instructions, when executed, are to cause the processor to determine a payment amount associated with the first payment request, wherein identifying the destination gateway comprises selecting a payment gateway associated with the merchant based on the payment amount.

16. The computing system claimed in claim 11, wherein the instructions, when executed, are to cause the processor to retrieve, by the second e-commerce platform, merchant parameters associated with a merchant account from memory, wherein the second payment request is generated based on the merchant parameters.

17. The computing system claimed in claim 11, wherein the first payment request is received at a built-in gateway associated with the second e-commerce platform and wherein the second payment request is generated by the built-in gateway.

18. (canceled)

19. The computing system claimed in claim 11, wherein the instructions, when executed, are to cause the processor to determine gateway payload requirements associated with the destination gateway, wherein the data payload associated with the first payment request is modified based on the gateway payload requirements.

20. A non-transitory, computer-readable medium storing computer-executable instructions that, when executed by a processor, are to cause the processor to:
receive a first payment request for a merchant transaction from a first e-commerce platform;
identify a destination gateway associated with the merchant at a second e-commerce platform; and
process the first payment request for the merchant transaction from the first e-commerce platform using the destination gateway associated with the merchant at the second e-commerce platform, the processing including:
obtaining one or more previously stored data modification parameters for the destination gateway and transaction data indicating a product category associated with the merchant transaction, the one or more data modification parameters stored in association with the merchant by the second e-commerce platform;
translating payment data associated with the first payment request to a request data format accepted by the destination gateway by generating a second payment request based on modifying the data payload associated with the first payment request using the one or more modification parameters for the destination gateway and data requirements for a gateway that is configured to process payment data for the product category; and
sending the second payment request to the destination gateway;
receive, from the destination gateway, a payment authorization response indicating whether a payment associated with the second payment request is authorized;
convert the payment authorization response to a response data format that matches the first payment request by generating a modified payment authorization response for the first e-commerce platform; and
forward the modified payment authorization response to a computing system associated with the first e-commerce platform.

21. The computer-readable medium of claim 20, wherein the instructions, when executed by the processor, are to cause the processor to store one or more payment request parameters associated with the first payment request, wherein the modified payment authorization response for the first e-commerce platform is generated based on the payment authorization response and the payment request parameters

22. The computer-readable medium of claim 20, wherein the instructions, when executed by the processor, are to cause the processor to determine a payment amount associated with the first payment request, wherein identifying the destination gateway comprises selecting a payment gateway associated with the merchant based on the payment amount.

23. The computer-readable medium of claim 20, wherein the instructions, when executed by the processor, are to cause the processor to retrieve, by the second e-commerce platform, merchant parameters associated with a merchant account from memory, wherein the second payment request is generated based on the merchant parameters.

24. The computer-readable medium of claim 20, wherein the first payment request is received at a built-in gateway associated with the second e-commerce platform and wherein the second payment request is generated by the built-in gateway.

25. The computer-readable medium of claim 20, wherein the instructions, when executed by the processor, are to cause the processor to determine gateway payload requirements associated with the destination gateway, wherein the data payload associated with the first payment request is modified based on the gateway payload requirements.

26. The computer-readable medium of claim 25, wherein the gateway payload requirements specify a payload size limit and wherein the data payload associated with the first payment request is compressed in accordance with the payload size limit.
